(19) United States
(12) Patent Application Publication
(10) Pub. No.: US 2026/0233313 A1
(43) Pub. Date: Aug. 13, 2026

(54) CUTTING TOOL WITH RADIALLY ADJUSTABLE CASSETTE

(71) Applicant: Kennametal Inc., Latrobe, PA (US)

(72) Inventors: Christian STRAUCHMANN, Eggolsheim (DE); Rainer BUETTNER, Wilhelmsdorf (DE); Berthold ZEUG, Fuerth (DE)

(21) Appl. No.: 19/536,786

(22) Filed: Feb. 11, 2026

(30) Foreign Application Priority Data
Feb. 12, 2025 (DE) 1020251051844

(51) Int. Cl. B23C 5/08; B23B 27/16; B23C 5/10; B23C 5/20; B23C 5/22; B23C 5/24

(52) U.S. Cl. CPC B23C 5/08; B23B 27/1622; B23C 5/10; B23C 5/109; B23C 5/20; B23C 5/2208; B23C 5/2462; B23C 5/2472

(57) ABSTRACT

A cutting tool comprising a tool body and a cassette for a cutting insert, wherein the cassette is radially adjustable along a direction of adjustment in a receptacle of the tool body by means of a positioning element with which the radial position of the cassette is adjustable in the receptacle in predetermined increments.

The invention relates to a cutting tool, for example a drill or mill, having a radially adjustable cassette for a cutting insert.

Cutting tools having a tool body and at least one cassette attached to the tool body for a cutting insert are known. Such cutting tools have the advantage that depending on the intended utilization scenario, the appropriate cassette can be selected and attached to the tool body in a receptacle.

The diameter of the cutting tool is defined by the width of the cassette radially to a longitudinal axis of the cutting tool as well as the size of the receptacle radially to the longitudinal axis of the cutting tool.

Typically, the cassettes are manufactured in a maximum width, which consequently determines the maximum diameter of the cutting tool. If the diameter of the cutting tool is to be reduced, it is therefore necessary to grind the cassette to the desired width. This process requires a lot of effort and is not reversible.

It is the object of the invention to provide a cutting tool with a diameter that is easily and precisely adjustable, in particular reversibly adjustable.

The object of the invention is solved by a cutting tool comprising a tool body and a cassette for a cutting insert, wherein the cassette is mounted radially adjustable in a receptacle of the tool body by means of a positioning element with which the radial position of the cassette in the receptacle is adjustable in predetermined increments along a direction of adjustment.

The invention is based on the basic idea of providing an additional positioning element for connecting the cassette to the tool body, wherein the positioning element allows the radial position of the cassette to be adjusted at predetermined increments, i.e., at predetermined intervals. In this way, the cassette itself does not need to be altered in order to alter the width of the cutting tool so that laborious grinding operations to remove material from the cassette may be omitted.

In addition, it is possible that the radial position of the cassette can be changed several times and in this way the cutting tool with various diameters can be utilized using the same cassette. Thus, for example, the diameter of the cutting tool is flexibly adaptable between two cutting operations.

The positioning element may be a screw comprising an axial portion having an external thread, whereby the axial portion extends parallel to the direction of adjustment. With the external thread, the positioning element can be reliably fixed relative to the cassette or the positioning element can be fixed relative to the receptacle of the tool body.

For example, the axial portion engages a counter thread in the cassette or tool body to connect the positioning element to the cassette or tool body, respectively. The counter thread may be formed in a receptacle of the cassette or the tool body.

At the same time, the predetermined increments along the direction of adjustment may be based on the thread pitch of the outer thread. In other words, the predetermined increments may be determined, among other things, via the choice of the thread pitch of the external thread.

Furthermore, the positioning element may comprise a fixing section by means of which the positioning element is fixed to the tool body or the cassette in a manner preventing rotation in a plane transverse to the direction of adjustment, in particular in a plane perpendicular to the direction of adjustment. By means of the fixing section, a secure hold of the positioning element during operation of the cutting tool is thus ensured, ensuring that the diameter does not change undesirably during operation of the cutting tool, for example due to radial forces acting on the positioning element and/or the cassette.

The fixing section is arranged in particular on the externally threaded end of the positioning element opposite to the axial section, such that the positioning element is connected at a first end through the axial section and at a second end through the fixation section to the cassette and the tool body and the cassette, respectively.

In order to secure the fixation section in a manner preventing rotation, the fixing section can be fixed in a form-locking manner to the tool body or the cassette. In this way, the positioning element is securely held and the components of the cutting tool are particularly easy to assemble.

For example, the fixing portion has a polygonal outer contour in the plane transverse to the direction of adjustment, in particular in the plane perpendicular to the direction of adjustment. In this way, the predetermined increments may be based on the number of outer surfaces of the fixing section predetermined by the polygonal outer contour.

In particular, the predetermined increments are based on a combination of the thread pitch of the outer thread of the axial portion and the number of outer surfaces of the fixing section predetermined by the polygonal outer contour.

Generally speaking, the type of polygonal outer contour is not further restricted as long as it ensures reliable fixing.

For example, the polygonal outer contour is a triangular, square, pentagonal, or hexagonal outer contour.

In order to be able to mount the fixing section more easily in the cassette or the receptacle, the polygonal outer contour can comprise at least one rounded corner. In addition, the wear of the components involved in the connection of the cassette and tool body is reduced by the use of rounded corners in the outer contour of the fixing section.

All corners of the polygonal outer contour may also be rounded.

The polygonal outer contour can be point-symmetric, in particular point-symmetric about a central longitudinal axis that runs through the positioning element and is parallel to the direction of adjustment of the cassette.

In one variant, the fixing section is inserted into a pocket of the tool body or the cassette, in particular in a form-locking manner. This results in a particularly simple assembly of the cassette on the tool body.

In addition, the fixing section may be non-destructively releasably inserted into the pocket such that the cassette is interchangeably inserted into the receptacle. This allows the same cassette to be removed and remounted in a different radial position.

Alternatively or additionally, a fastener of the tool body or the cassette may engage the fixing portion. Stated another way, the fixing section may have a recess into which the fastener engages.

The configurations previously explained for the polygonal outer contour of the fixing section apply analogously to the fastening element and the recess of the fixing section.

The fixing section may be a head of the positioning element, in particular having a larger diameter than the axial portion with the external thread.

The pocket may have a plurality of circumferential abutment surfaces, whereby each of the circumferential abutment surfaces are in contact with a lateral surface of the fixing section. The interaction between the abutment surfaces of the pocket and the lateral surfaces of the fixing section ensures that the fixing section is secured in a particularly simple manner preventing rotation, in particular by means of a positive form locking.

The pockets may also have fewer circumferential abutment surfaces than the fixing section has lateral surfaces as long as sufficient circumferential abutment surfaces are present to securely hold the fixing section against rotation. In other words, the pocket may be an at least one-sided open pocket. Such a configuration may also further simplify the insertion of the fixing section into the tool body or the cassette.

Alternatively, the pocket may enclose the fixing section in the plane transverse to the direction of adjustment, in particular in the plane perpendicular to the direction of adjustment, on all sides. In this way, the fixing section can be secured particularly well against radial forces during operation of the cutting tool.

The direction of adjustment is in particular perpendicular to a longitudinal axis of the tool body. In this way, a change in the radial position of the cassette translates immediately to a change in the diameter of the cutting tool.

The type of cutting tool is not further restricted. Particularly advantageous is the possibility of adjusting the diameter of the cutting tool by changing the radial position of the cassette in a rotary cutting tool. The cutting tool is, for example, a drill or a mill.

In addition to the positioning element, the cassette may be attached to the tool body by one or more further means. In this way, the requirements for connection via the positioning element can be reduced.

For example, the cassette can additionally be fixed in the receptacle by means of a fastening screw, wherein the fastening screw extends transversely to the direction of adjustment, in particular perpendicular to the direction of adjustment.

The direction of adjustment can thus be transverse to the longitudinal axis of the cutting tool, in particular perpendicular to the longitudinal axis of the cutting tool.

Further features and characteristics of the invention are apparent from the following description of exemplary embodiments, which should not be understood in a restrictive sense, as well as from the drawings. The figures show:

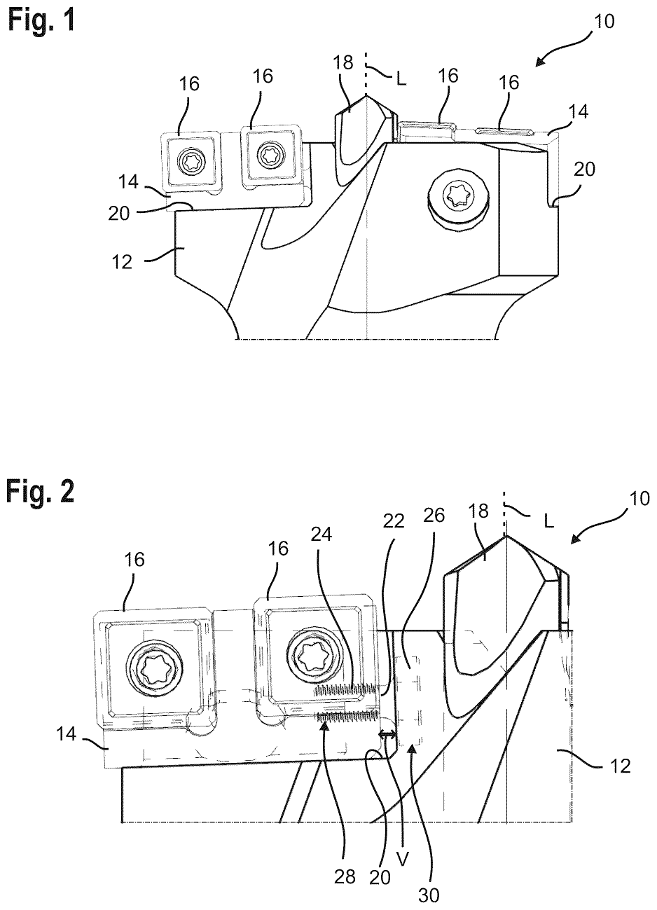

FIG. 1 a side view of a cutting tool according to the invention,

FIG. 2 a partially transparent illustration of selected components of the cutting tool of FIG. 1,

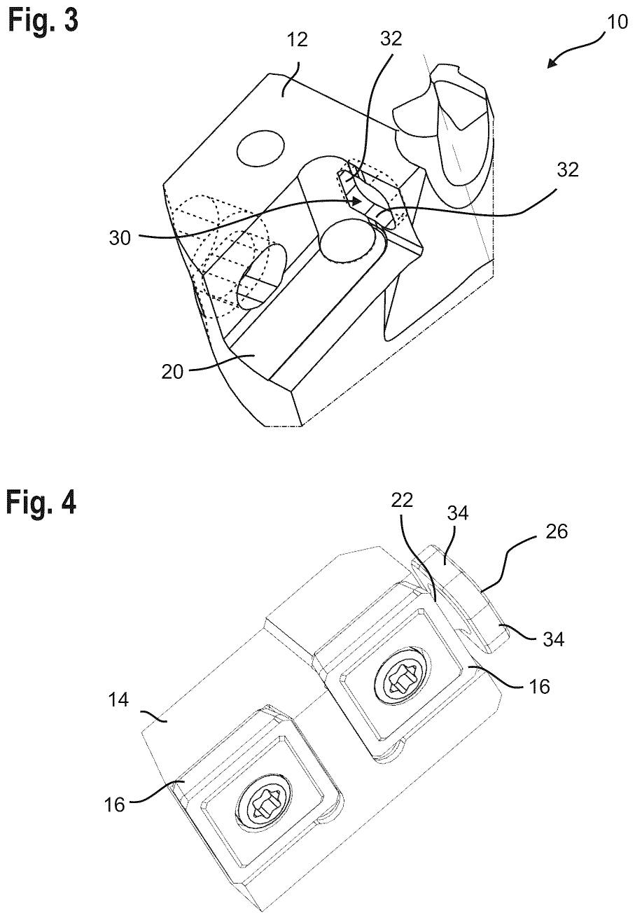

FIG. 3 a perspective view of a tool body of the cutting tool of FIG. 1,

FIG. 4 a perspective view of a cassette of the cutting tool of FIG. 1,

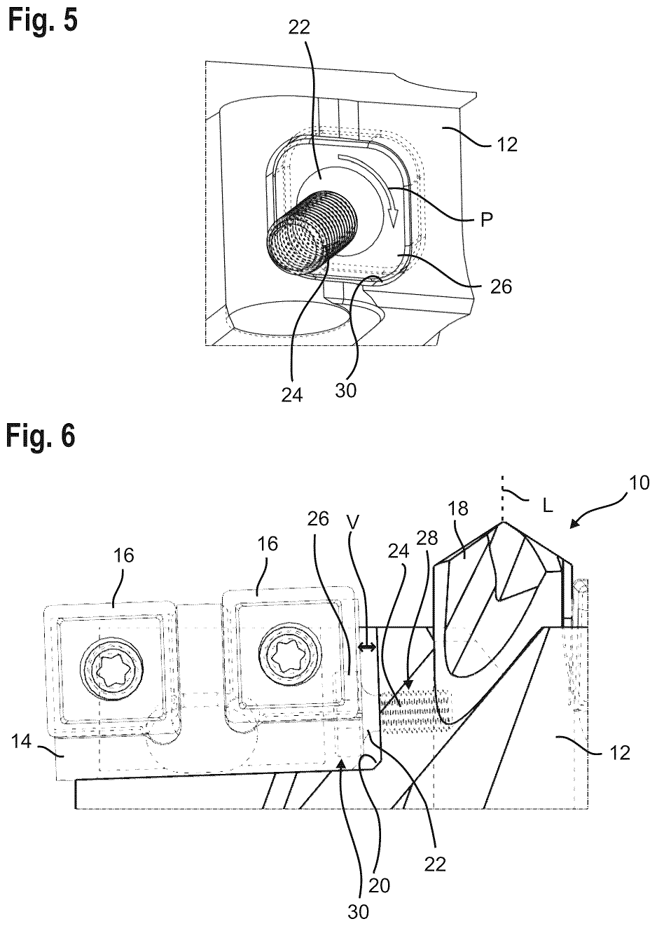

FIG. 5 a perspective view of a mounting position of a positioning element of the cutting tool of FIG. 1,

FIG. 6 a partially transparent illustration of selected components of a modification of the cutting tool of FIG. 1,

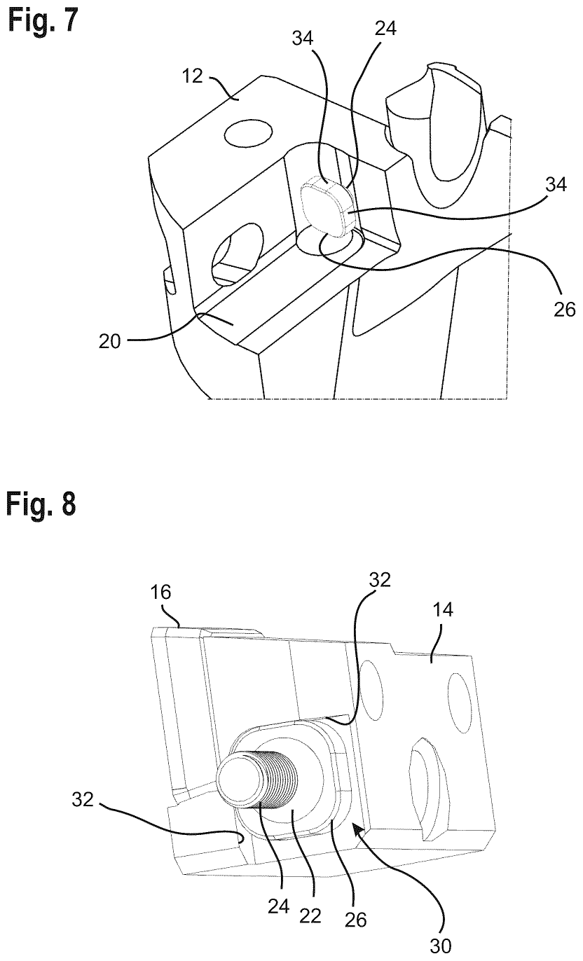

FIG. 7 a perspective view of a tool body of the cutting tool of FIG. 6, and

FIG. 8 a perspective view of a cassette of the cutting tool of FIG. 6.

FIG. 1 shows a cutting tool 10 according to the invention having a tool body 12 in which two cassettes 14 are inserted, in which in turn a plurality of cutting inserts 16 are each mounted.

It goes without saying that also only one cassette 14 or more than the two cassettes 14 shown in FIG. 1 may be present. Likewise, fewer or more cutting inserts 16 may be present per cassette 14 than in the embodiment shown.

The cutting tool 10 further includes a centering pin 18 oriented centrally along a longitudinal axis L of the tool body 12, the longitudinal axis L being an axial direction of the tool body 12.

The cutting tool 10 is a rotary cutting tool configured to rotate about the longitudinal axis L during operation to perform cutting operations on a workpiece to be machined (not shown).

In the illustrated embodiment, the cutting tool 10 is a spiral drill. However, the cutting tool may also be another form of cutting tool, for example, other forms of a drill or a mill.

The cassettes 14 are each mounted in an associated receptacle 20 of the tool body 12.

The width of the cassettes 14 is sized such that they protrude from or are flush with the receptacle 20 in a radial direction that is perpendicular to the longitudinal direction L. Thus, the diameter of the cutting tool 10 is not only defined across the width of the tool body 12, but also across the radial position of the cassettes 14.

The radial position of each of the cassettes 14 is adjustable along an adjustment direction V via a positioning element 22 associated with the respective cassette 14, which can be seen in the partially transparent illustration in FIG. 2.

The positioning element 22 is a screw comprising an axial portion 24 having an external thread as well as a fixing section 26, which in the embodiment shown is configured as the head of the screw and has a larger diameter than the axial portion 24.

The axial portion 24 extends parallel to the adjustment direction V and is arranged at a first axial end of the positioning element 22.

The axial portion 24 engages with a receptacle 28 of the cassette 14, which has a counter thread corresponding to the external thread of the axial portion 24, such that the positioning element 22 can be screwed into the cassette 14 or screwed out of the cassette 14.

The fixing section 26 is disposed at a second axial end of the positioning element 22 opposite to the first axial end and inserted into a pocket 30 of the tool body 12.

FIG. 3 shows a perspective view of tool body 12 in which the pocket 30 is more readily recognizable.

The pocket 30 has a substantially square inner contour with a plurality of circumferential abutment surfaces 32 joined together via rounded corners.

As can be seen in the perspective view of FIG. 4, the fixing section 26 has a shape corresponding to the pocket 30. Accordingly, the fixing section 26 has a square outer contour with rounded corners in a plane transverse to the direction of adjustment V, namely in a plane perpendicular to the direction of adjustment V.

Accordingly, the fixing section 26 has four side surfaces 34 that are in contact with the circumferential abutment surfaces 32 of the pocket 30 in the mounting position of the cassette 14 and the positioning element 22, as can be seen particularly well in the detail illustration in FIG. 5.

Due to the interaction of the fixing section 26 and the pocket 30, the positioning element 22 is fixed to the tool body 12 in a manner preventing rotation in the plane transverse to the direction of adjustment V. Put another way, rotation along the arrow P shown in FIG. 5 is not possible as long as the fixing section 26 is inserted in the pocket 30.

In this way, the radial position of the cassette 14 is defined by the position of the fixing section 26 in the pocket 30 as well as the screw depth of the axial portion 24 in the cassette 14.

The resulting positive form locking between the fixing section 26 and the pocket 30 prevents the radial position of the cassette 14 from undesirably changing during operation of the cutting tool 10.

If the radial position of the cassette 14, and thus the resulting diameter of the cutting tool 10, is to be changed, the cassette 14 can be withdrawn together with the positioning element 22 from the pocket 30, the screw depth of the positioning element 22 can be changed by rotating the positioning element 22, for example by rotating the fixing section 26, and the fixing section 26 can then be inserted again into the pocket.

According to the invention, it is provided that the radial position of the cassette 14 in the receptacle 20 is adjustable in predetermined increments, that is, only in defined multiples of a defined interval.

In the embodiment shown, the predetermined increments are based on an interplay between the thread pitch of the outer thread of the axial portion 24 and the outer contour of the fixing section 26.

As can be seen in FIG. 5, the fixing section 26 can only be inserted into the pocket 30 of the tool body 12 if the lateral surfaces 34 defined by the outer contour of the fixing section 26 are complementary to the alignment of the abutment surfaces 32 of the pocket 30.

In the illustrated embodiment in which the fixing section 26 has a substantially square outer contour, this means that the fixing section 26 must be twisted 90° before the fixing section 26 is again aligned such that it can be inserted into the pocket 30.

In other words, per full revolution of the fixing section 26 with a substantially square outer contour, there are four possible orientations of the fixing section 26 that allow the fixing section to be inserted into the pocket 30.

The interplay of the rotation by 90° and the thread pitch of the external thread of the axial section 24 results in a change of the screw depth of the positioning element 22 into the cassette 14 between two possible insertion positions of the positioning element 22, which corresponds to the predetermined increment (i.e., one quarter of the gear height of the thread in this example), meaning the increment in which the radial position of the cassette 14 in the receptacle 20 is adjustable.

It goes without saying that the predetermined increment can be altered via the configuration of the external thread as well as the fixing section 26.

In particular, the fixing section 26 can also have an outer contour that is different from the embodiment shown in the figures. The only decisive factor is that the fixing section is fixed to the tool body 12 in a manner preventing rotation.

Thus, the fixing section 26 can have any polygonal outer contour in the plane transverse to the adjustment direction V, as long as the pocket 30 can hold the resulting fixing section 26 in a manner preventing rotation, for example, by having an inner contour that is complementary to the polygonal outer contour of the fixing section 26.

The polygonal outer contour corresponds in particular to a regular polygon. For example, instead of a square outer contour, the fixing section 26 can have a triangular, pentagonal, or hexagonal outer contour.

FIG. 6 illustrates a modification of the cutting tool 10 that substantially corresponds to the cutting tool previously described, so that only differences will be discussed below. The same reference numerals indicate the same or functionally identical components and reference is made to the above.

In the modification of the cutting tool 10, the pocket 30 is not disposed in the tool body 12 but instead in the cassette 14. At the same time, the receptacle 28 is not disposed in the cassette 14 but in the tool body 12.

Accordingly, the axial portion 24 engages with the tool body 12 and the fixing section 26 is fixed in the cassette 14 in a manner preventing rotation.

FIG. 7 shows a perspective view of tool body 12 analogous to FIG. 3, whereby the positioning element 22 is already screwed into tool body 12.

FIG. 8 shows a perspective view of the cassette 14 according to the modification of the cutting tool 10.

As can be seen in FIG. 8, the pocket 30 has fewer circumferential abutment surfaces 32 in the modification than the fixing section 26 has lateral surfaces 34. Thus, the pocket 30 is open and the fixing section 26 is not enclosed on all sides by the pocket 30. Nevertheless, via the existing abutment surfaces 32, it is further ensured that the fixing section 26 can only be received and secured in predetermined alignments in the pocket 30 so that the radial position of the cassette 14 can be changed in predetermined increments.

Overall, the cutting tool according to the invention is characterized in that the position of the cassette 14 and thus the diameter of the cutting tool 10 can be adjusted precisely and in a few simple steps.

1: A cutting tool comprising a tool body and a cassette for a cutting insert, whereby the cassette is radially adjustable along a direction of adjustment in a receptacle of the tool body by means of a positioning element with which the radial position of the cassette is adjustable in the receptacle in predetermined increments.

2: The cutting tool according to claim 1, wherein the positioning element is a screw comprising an axial portion having an outer thread, and wherein the axial portion extends parallel to the direction of adjustment.

3: The cutting tool according to claim 1, wherein the positioning element comprises a fixing section by means of which the positioning element is fixed in a manner preventing rotation in a plane transverse to the direction of adjustment to the tool body or the cassette.

4: The cutting tool according to claim 3, wherein the fixing section is positively secured to the tool body or the cassette.

5: The cutting tool according to claim 3, wherein the fixing section has a polygonal outer contour in the plane transverse to the direction of adjustment.

6: The cutting tool according to claim 5, wherein the polygonal outer contour is point-symmetric.

7: The cutting tool according to claim 3, wherein the fixing section is inserted into a pocket of the tool body or the cassette.

8: The cutting tool according to claim 7, wherein the pocket comprises a plurality of circumferential abutment surfaces, and each of the circumferential abutment surfaces is in contact with a lateral surface of the fixing section.

9: The cutting tool according to claim 1, wherein the adjustment direction is perpendicular to a longitudinal axis of the tool body (12).

10: The cutting tool according to claim 1, wherein the cutting tool is a drill or mill.
